(19) United States
(12) Patent Application Publication
(10) Pub. No.: US 2009/0040232 A1
(43) Pub. Date: Feb. 12, 2009

(54) METHOD TO RECORD BUS DATA IN A GRAPHICS SUBSYSTEM THAT USES DMA TRANSFERS

(76) Inventors: MANJUNATH BASAPPA MUTTUR, Kolar Gold Fields (IN); George Francis Ramsay, III, Elgin, TX (US); Robert Paul Stelzer, Austin, TX (US)

Correspondence Address: IBM CORP (YA);C/O YEE & ASSOCIATES PC, P.O. BOX 802333, DALLAS, TX, 75380, US

(21) Appl. No.: 11/837,363

(22) Filed: Aug. 10, 2007

(51) Int. Cl. G06T 1/00

(52) U.S. Cl. 345/522

(57) ABSTRACT

In a graphics based subsystem based on direct memory access transfer, a user queue library is used by the application program interface to send graphic command data to the graphics adapter. The user queue library transfers data stored within the user queue to the graphics adapter using direct memory access transfers. The user queue library determines whether the data should be saved. The application program interface calls a user queue routine from a user queue library. The user queue routine saves the control data to a trace file in memory. The user queue routine then transfers the graphics command data to the graphics adapter using a direct memory access transfer.

### BACKGROUND OF THE INVENTION

1. Field of the Invention

The present invention relates generally to computer implemented methods, data processing systems, and computer product codes. More specifically, the present invention is related to computer implemented methods, data processing systems, and computer product codes for recording bus data in a graphics subsystem using direct memory access transfers.

2. Description of the Related Art

Direct memory access (DMA) is a feature of modern computers that allows certain hardware subsystems within the computer to access system memory for reading and/or writing independently of the central processing unit. Many hardware systems use DMA including disk drive controllers, graphics cards, network cards, and sound cards. Computers that have DMA channels can transfer data to and from devices with much less CPU overhead than computers without a DMA channel.

Without DMA, using programmed input/output (PIO) mode, the CPU typically has to be occupied for the entire time it is performing a transfer. With DMA, the CPU would initiate the transfer, do other operations while the transfer is in progress, and receive an interrupt from the DMA controller once the operation has been done. This is especially useful in real-time computing applications where not stalling behind concurrent operations is critical.

In a graphics subsystem utilizing DMA, if invalid graphic command data is sent through the PCI bus to the graphics adapter, the adapter will hang and will become unresponsive to new inputs. If the graphics adapter is in a hung state, the graphic command data stream that was sent to the adapter is lost. A developer must then determine the cause of the hang in order to prevent recurrence of the problem.

Determining the cause of the hang is usually performed by attaching a hardware analyzer, monitoring the PCI bus, and then recreating the hanging event. The hardware analyzer will show the graphic command data that was sent to the graphics adapter before the hang occurs. This is accomplished through the hardware analyzer's capturing the actual physical communications that occur on the bus, including detailed timing analysis, such as the time to send the command, data, messaging, etc. However, hardware analyzers are typically expensive and bulky. Furthermore, the hardware analyzer requires that a bus monitoring card be inserted into a PCI slot of the monitored graphics adapter.

### SUMMARY OF THE INVENTION

The present invention provides computer implemented methods, data processing systems, and computer product codes for recording data. Graphic command data is received in a user queue. Responsive to receiving the graphic command data in the user queue, the graphic command data and control data are copied to a trace file. Further, responsive to receiving the graphic command data in the user queue, the graphic command data is transferred from the user queue to a graphics adapter.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 depicts a block diagram of a data processing system in which illustrative embodiments may be implemented;

FIG. 3 depicts a block diagram of the flow of data through the various hardware and software components in accordance with an illustrative embodiment;

FIG. 4 is a flowchart of a process for processing control data within a user queue library in accordance with an illustrative embodiment; and

FIG. 5 is a flowchart of a process for processing application data being sent to a user queue library in accordance with an illustrative embodiment.

### DETAILED DESCRIPTION OF THE PREFERRED EMBODIMENT

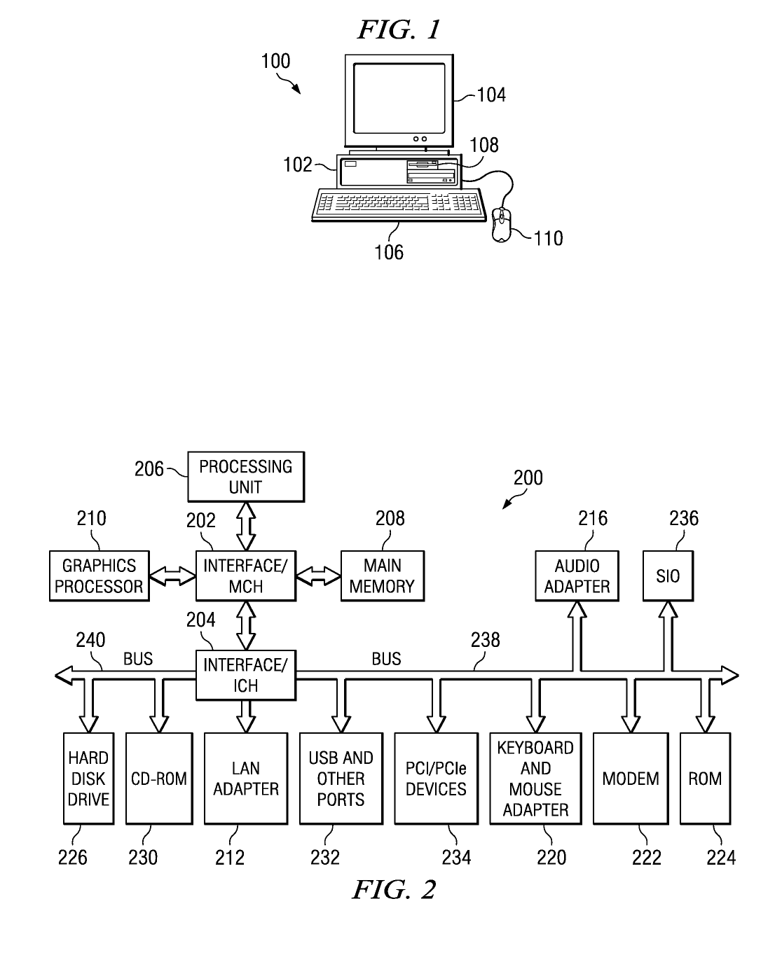

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices could include, for example, a joystick, a touchpad, a touch screen, a trackball, and a microphone.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including an interface and memory controller hub (interface/MCH) 202 and an interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to interface and memory controller hub 202 through an accelerated graphics port (AGP), for example.

In the depicted example, local area network (LAN) adapter 212 is coupled to interface and I/O controller hub 204, audio adapter 216, keyboard and mouse adapter 220, modem 222, read only memory (ROM) 224, universal serial bus (USB) and other ports 232. PCI/PCIe devices 234 are coupled to interface and I/O controller hub 204 through bus 238. Hard disk drive (HDD) 226 and CD-ROM 230 are coupled to interface and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206. This operating system coordinates and controls various components within data processing system 200 in FIG. 2. The operating system may be a commercially available operating system, such as Microsoft® Windows Vista™. (Microsoft® and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in interface and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

In a graphics based subsystem based on direct memory access transfer, a user queue library is used by the application program interface to send graphic command data to the graphics adapter. The user queue library transfers data stored within the user queue to the graphics adapter using direct memory access transfers.

When the application program interface creates a user queue to write graphic command data into, the user queue library determines whether the data should be saved. This check could be done using an environmental variable.

The application program interface will write the graphic command data into the user queue. The application program interface will then call a user queue routine from a user queue library to execute a direct memory access transfer of graphic command data to the graphics adapter. Before transferring any graphic command data to the graphics adapter, the user queue routine responsible for transferring graphic command data to the graphics adapter will save off the data to a trace file in memory. The user queue routine will then transfer the graphic command data to the graphics adapter using a direct memory access transfer.

Because a single graphics adapter and user queue library can be used for multiple threads running simultaneously, all graphic command data transferred to the graphics adapter is synchronized within the user queue. Since the data is saved, it can be written to a file. The ID of the thread and internal user queue commands can be saved. This could include the following: GETUQ, FLUSHUQ, RELEASEUQ, SETRCX, the context ID of the thread, as well as instructions to the graphics adapter.

Data being sent through the bus using the user queue library is recorded to a trace file before the adapter is hung so a hardware analyzer is not necessary. A programmer can enable this invention and examine the exact data that was being sent through the PCI bus when the hang occurred, without the need of a hardware analyzer.

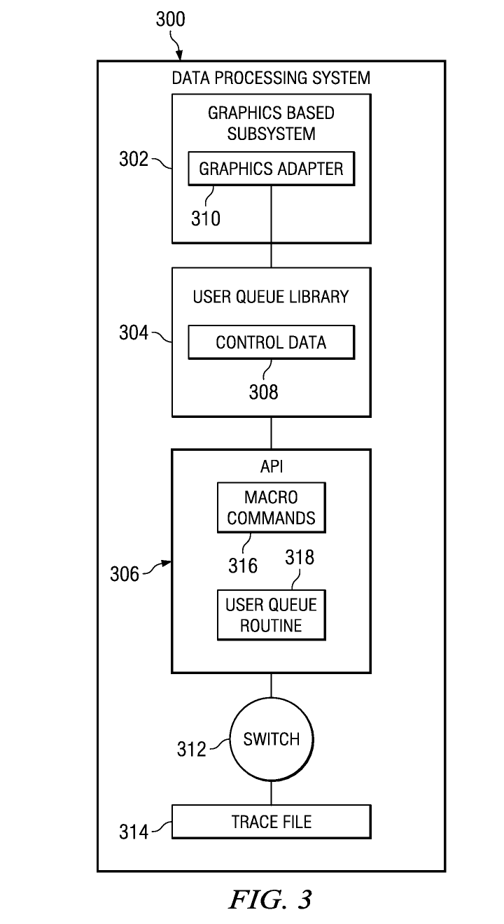

Referring now to FIG. 3, a block diagram of the flow of data through the various hardware and software components is depicted in accordance with an illustrative embodiment. The data flow of FIG. 3 is shown as implemented within a data processing system, such as data processing system 200 of FIG. 2.

Data processing system 300 contains graphics based subsystem 302. Generally, a graphics subsystem includes the graphics accelerator, graphics memory, video connectors, NTSC video output encoder, and associated software drivers. Specifically, graphics based subsystem 302 includes graphics adapter 310. Data processing system 300 utilizes DMA transfers to allow hardware subsystems to access system memory for reading and/or writing independently of a central processing unit. User queue library 304 is used by application program interface (API) 306 to DMA transfer a pinned piece of memory user queue 324, containing graphics commands to the graphics adapter 310.

API 306 makes a call to UQ Library 304 to create user queues 324 into which data can be written. When user queue 324 is created, user queue library 304 determines whether data should be saved. The data being saved can include the context identification of the thread utilizing the data, instructions to the graphics adapter, and internal user queue commands, such as GETUQ, FLUSHUQ, RELEASEUQ, SETRCX.

The determination of whether data should be saved can be ascertained using an environmental variable. When a problem, such as a hang, is encountered, a programmer can enable environment variable 312. When activated, environmental variable 312 causes user queue library 304 to save off user queue macro commands 316 to trace file 314. Graphic command data 317 within user queue 324 is also saved to trace file 314 before being sent using DMA transfers to the graphics adapter 310. Graphic command data 317 provides instructions to graphics adapter 310. Upon recreation of the hanging event, a programmer has a complete record of data received by graphics adapter 310 as recorded into the trace file.

API 306 uses the macro commands 316 to obtain a user queue 324. The API 306 will also write graphic command data 317 into user queue 324. Macro commands 316 are used to call the functions stored within user queue library 304. Each time that a macro command is used the user queue library 304 writes macro commands 316 to trace file 314. Graphic command data 317 in user queue 324 is written to trace file 314 just before the DMA transfer to that graphics adapter 310. Macro commands 316 can include one or more of the following:

GETUQ—this macro command allocates a piece of memory into which graphic command data 317 can be written. GETUQ also allows a programmer examining trace file 314 to determine the start of a series of instructions to graphics adapter 310.

FLUSHUQ—this macro will save off the graphic command data in the user queue 324 to a trace file 314 when the environment variable 312 is enabled. It issues a DMA transfer of graphic command data 317 stored within user queue 324 to graphics adapter 310.

RELEASEUQ—this macro command releases control of a user queue filled with graphic command data. Graphic command data stored within a released user queue is discarded. The memory used by the user queue is then freed for use by other user queues or threads.

SETRCX—this macro command installs a threads graphics context to the graphics adapter 310. Because the illustrative embodiments can be utilized in a multithreaded environment, a context switch must be utilized. A context switch is the computing process of storing and restoring the state of the graphics processor such that multiple processes can share the same resources. SETRCX installs the graphics context to graphics adapter 310 so the graphics adapter 310 will be at the same state when the thread was executed previously.

If it was determined that graphic command data 317 in the user queue 324 should be saved, environmental variable 312 will cause user queue library 304 to write graphic command data 317 to trace file 314 before it is sent to the graphics adapter 310 using DMA transfers. By writing graphic command data 317 to trace file 314 before it is sent to the graphics adapter 310, a programmer is provided with a complete record of data received by graphics adapter 310 as recorded into trace file 314.

API 306 then calls user queue routine 318 to DMA transfer graphic command data 317 in user queue 324 to graphics adapter 310. User queue routine 318 can be a macro command, such as macro command 316 FLUSHUQ. Data is sent to graphics adapter 310 using DMA transfers. The user queue library transfers the user queue data to the graphics adapter using DMA transfers. Since all multiple thread use user queue library 304, graphic command data 317 being sent to the graphics adapter 310 and to trace file 314 is synchronized.

Thus, by examining the trace file, a programmer is provided with all of the information that is needed to determine that a group of commands that are transferred to the graphics adapter is a single user queue. Each single user queue would be preceded by a GETUQ macro command and followed by a FLUSHUQ macro command. Each instruction to the graphics adapter between these two macro commands would necessarily be part of the same group of commands for a single user queue.

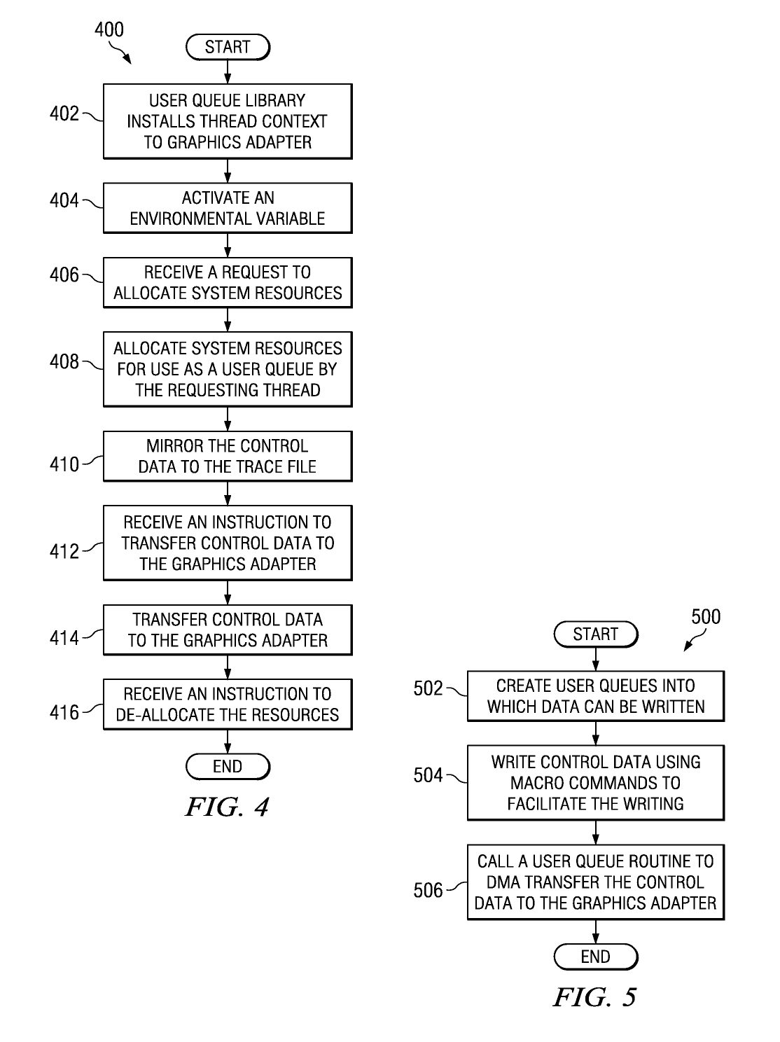

Referring now to FIG. 4, a flowchart of a process for processing data within a user queue library is shown in accordance with an illustrative embodiment. Process 400, as shown in FIG. 4, is a software process implemented in conjunction with the user queue library of FIG. 3.

The process begins with a user queue library installing a thread context to the graphics adapter (step 402). The installation can utilize a macro command, such as macro command 316 SETRCX of FIG. 3. Because the illustrative embodiments can be utilized in a multithreaded environment, a context switch must be utilized. A context switch is the computing process of storing and restoring the state of the processor such that multiple processes can share the same resources. SETRCX installs the graphics context of the current thread to graphics adapter 310 of FIG. 3. Furthermore, SETRCX sets the state of graphics adapter 310 of FIG. 3 to the last state when the thread executed previously.

In response to a hang in a graphics adapter, a programmer can activate an environmental variable (step 404). The environmental variable can be implemented as a switch. By activating the environmental variable, the programmer has instructed the user queue library that subsequent control data received by the user queue library should be saved to a trace file. The control data contains information such as the graphic command data as well as any other data being processed by the user queue library.

The user queue library receives a request to allocate system resources for a user queue (step 406). The request can be a macro command, such as macro command 326 GETUQ of FIG. 3. Process 400 then allocates system resources for use as a user queue by the requesting thread (step 408).

Upon the receipt of subsequent control data in the user queue library, process 400 mirrors the control data to the trace file (step 410). Upon recreation of the hanging event, a programmer has a complete record of the control data which includes the graphic command data received by the graphics adapter as recorded into the trace file. Control data can include macro commands used to call the functions stored within the user queue library, the context ID of the thread, and any instructions to the graphics adapter.

Process 400 then receives an instruction to transfer the graphic command data stored in the user queue to the graphics adapter (step 412). The instruction can be a macro command, such as macro command 326 FLUSHUQ of FIG. 3. Responsive to receiving the instruction, process 400 transfers the data to the graphics adapter using a direct memory access transfer (step 414). Graphic command data is sent from the user queue to the graphics adapter by the user queue library using a direct memory access transfer.

Should the thread no longer need the allocated user queue and system resources, the user queue library may optionally receive an instruction to de-allocate the resources for the user queue (step 416), with the process terminating thereafter.

Referring now to FIG. 5, a flowchart of a process for processing application data being sent to a user queue library is shown in accordance with an illustrative embodiment. Process 500, as shown in FIG. 5, is a software process, such as API 306 in FIG. 3.

Process 500 creates user queues into which graphic command data can be written (step 502).

Process 500 then writes graphics command data into the created user queue (step 504).

Process 500 then calls a user queue routine, such as user queue routine 318 of FIG. 3 to DMA transfer the graphic command data to the graphics adapter (step 506). Before the data is sent to the graphics adapter, the graphics context of the current thread is placed on the graphics adapter. The context ID is written to trace the file. The GETUQ command is written to the trace file as well as the graphic command data in the user queue. The graphic command data in the user queue is sent using DMA to the graphics adapter, with the process terminating thereafter. The user queue routine can be a macro command, such as macro command 316 FLUSHUQ of FIG. 3.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in a data processing system for recording data, the computer implemented method comprising:
receiving graphic command data in a user queue;
responsive to receiving the graphic command data in the user queue, copying a control data to a trace file; and
further responsive to receiving the graphic command data in the user queue, transferring the graphic command data from the user queue to a graphics adapter.

2. The computer implemented method of claim 1, wherein the step of copying the control data to the trace file is further in response to activating an environmental variable to indicate that the control data should be copied to the trace file.

3. The computer implemented method of claim 1, wherein the control data comprises at least one of a context identification of a thread to utilize the graphics adapter, a set of instructions to the graphics adapter, and at least one internal user queue command.

4. The computer implemented method of claim 3, wherein the at least one internal user queue command is a macro command selected from a group consisting of GETUQ, FLUSHUQ, RELEASEUQ, SETRCX.

5. The computer implemented method of claim 1, wherein the step of transferring the control data from the user queue to the graphics adapter is direct memory access transfer.

6. The computer implemented method of claim 3, wherein the at least one internal user queue command is at least two internal user queue commands consisting of a GETUQ macro command and a FLUSHUQ macro command, and wherein the control data comprises, in order, the GETUQ macro command, the set of instructions to the graphics adapter, and the FLUSHUQ macro command.

7. A computer program product in a computer-readable medium, the computer program product comprising:
First instructions for receiving graphic command data in a user queue;
responsive to receiving the graphic command data in the user queue, second instructions for copying a control data to a trace file; and
further responsive to receiving the graphic command data in the user queue, third instructions for transferring the graphic command data from the user queue to a graphics adapter.

8. The computer program product of claim 7, wherein the second instructions are further in response to activating an environmental variable to indicate that the control data should be copied to the trace file.

9. The computer program product of claim 7, wherein the control data comprises at least one of a context identification of a thread to utilize the graphics adapter, a set of instructions to the graphics adapter, and at least one internal user queue command.

10. The computer program product of claim 9, wherein the at least one internal user queue command is a macro command selected from a group consisting of GETUQ, FLUSHUQ, RELEASEUQ, SETRCX.

11. The computer program product of claim 7, wherein the step of transferring the graphic command data from the user queue to the graphics adapter is direct memory access transfer.

12. The computer program product of claim 9, wherein the at least one internal user queue command is at least two internal user queue commands consisting of a GETUQ macro command and a FLUSHUQ macro command, and wherein the control data comprises, in order, the GETUQ macro command, the set of instructions to the graphics adapter, and the FLUSHUQ macro command.

13. A data processing system comprising:
a memory containing a set of instructions;
a bus system connecting the memory to a processor; and
the processor, responsive to execution of the set of instructions, for receiving graphic command data in a user queue, responsive to receiving the graphic command data in the user queue, for copying a control data to a trace file, and further responsive to receiving the graphic command data in the user queue, for transferring the graphic command data from the user queue to a graphics adapter.

14. The data processing system of claim 13, wherein the step of copying the control data to the trace file is further in response to activating an environmental variable to indicate that the control data should be copied to the trace file.

15. The data processing system of claim 13, wherein the control data comprises at least one of a context identification of a thread to utilize the graphics adapter, a set of instructions to the graphics adapter, and at least one internal user queue command.

16. The data processing system of claim 15, wherein the at least one internal user queue command is a macro command selected from a group consisting of GETUQ, FLUSHUQ, RELEASEUQ, SETRCX.

17. The data processing system of claim 13, wherein the step of transferring the control data from the user queue to the graphics adapter is direct memory access transfer.

18. The data processing system of claim 15, wherein the at least one internal user queue command is at least two internal user queue commands consisting of a GETUQ macro command and a FLUSHUQ macro command, and wherein the control data comprises, in order, the GETUQ macro command, the set of instructions to the graphics adapter, and the FLUSHUQ macro command.
